(19) United States
(12) Patent Application Publication
(10) Pub. No.: US 2007/0078767 A1
(43) Pub. Date: Apr. 5, 2007

(54) Prepaid debit card processing

(76) Inventor: Simcha Gendelman, Reut (IL)

Correspondence Address: WELSH & KATZ, LTD, 120 S RIVERSIDE PLAZA, 22ND FLOOR, CHICAGO, IL, 60606, US

(21) Appl. No.: 10/577,610

(22) PCT Filed: Oct. 14, 2004
(86) PCT No.: PCT/IL04/00946

§ 371 Date: Sep. 25, 2006

(30) Foreign Application Priority Data
Oct. 30, 2003 (IL) 158694

(51) Int. Cl. G06Q 40/00

(52) U.S. Cl. 705/44; 705/38

(57) ABSTRACT

A method for processing prepaid card transactions including issuing a multiplicity of prepaid cards, each bearing prepaid card identification indicia, inputting the prepaid card identification indicia of a prepaid card into a point of sale terminal, communicating the prepaid card identification indicia from the point of sale terminal to a remote server to validate the prepaid card and upon receipt of acceptable validation from the remote server, processing a prepaid card transaction using the prepaid card as a credit card transaction.

### FIELD OF THE INVENTION

The present invention relates to methods for processing debit card transactions, and more specifically to methods for processing pre-paid debit card transactions.

### BACKGROUND OF THE INVENTION

Existing methods for processing prepaid card transactions involve the processing of complicated, multiple transactions to ensure that the proper card issuer account and prepaid card account are appropriately settled.

### SUMMARY OF THE INVENTION

The present invention seeks to provide improved methods for processing prepaid card transactions.

The present invention simplifies the transaction process for prepaid cards by omitting the complicated settlement between the card issuer and the merchant, since the process payment to the merchant is based on a credit card system. This simplifies the transaction flow.

It is noted that throughout the specification and claims the phrase “prepaid card” refers to an instrument presented by a user in a purchase or payment transaction, such that the value of the purchase or payment is paid by a third party issuer of the instrument without regard to the identity of the specific user.

There is thus provided in accordance with a preferred embodiment of the present invention a method for processing prepaid card transactions including issuing a multiplicity of prepaid cards, each bearing prepaid card identification indicia, inputting the prepaid card identification indicia of a prepaid card into a point of sale terminal, communicating the prepaid card identification indicia from the point of sale terminal to a remote server to validate the prepaid card and upon receipt of acceptable validation from the remote server, processing a prepaid card transaction using the prepaid card as a credit card transaction.

In accordance with another preferred embodiment of the present invention the processing a prepaid card transaction using the prepaid card as a credit card transaction includes charging a credit card account identified by conventional credit card identification indicia for the amount of the prepaid card transaction. Additionally, the credit card account corresponds to at least a plurality of the multiplicity of prepaid cards.

In accordance with yet another preferred embodiment of the present invention the credit card identification indicia is stored at the point of sale terminal. Additionally, the credit card identification indicia is accessed at the point of sale terminal using the prepaid card identification indicia.

In accordance with still another preferred embodiment of the present invention the credit card identification indicia is stored at the remote server. Additionally, the credit card identification indicia is accessed at the remote server using the prepaid card identification indicia.

In accordance with another preferred embodiment of the present invention the inputting includes reading the identification indicia. Alternatively, the inputting includes keying in the identification indicia.

Preferably, the acceptable validation includes balance information.

There is also provided in accordance with another preferred embodiment of the present invention a point of sale terminal including an input device operative to receive prepaid card identification indicia from a prepaid card and a processor, operative to process a prepaid card transaction using the prepaid card as a credit card transaction.

Preferably, the input device is a card reader. Alternatively, the input device is a keyboard.

In accordance with another preferred embodiment of the present invention the processor is operative to verify acceptable validity of the prepaid card prior to processing the prepaid card transaction. Additionally or alternatively, the processor is operative to verify a balance associated with the prepaid card prior to processing the prepaid card transaction.

In accordance with yet another preferred embodiment of the present invention the point of sale terminal also includes a communicator, operative to communicate the prepaid card identification indicia to a remote server to determine validity of the prepaid card. Additionally, the remote server is operative to communicate a balance in the prepaid card, via the communicator, to the terminal.

In accordance with still another preferred embodiment of the present invention the processor is operative to charge a credit card account identified by conventional credit card identification indicia for the amount of the prepaid card transaction. Additionally, the point of sale terminal also includes a storage device for storing the credit card identification indicia.

### BRIEF DESCRIPTION OF THE DRAWINGS

The present invention will be understood and appreciated more fully from the following detailed description, taken in conjunction with the drawings in which:

FIG. 1 is a simplified pictorial illustration of a prepaid card transaction process constructed and operative in accordance with a preferred embodiment of the present invention;

FIG. 2 is a simplified pictorial illustration of another prepaid card transaction process constructed and operative in accordance with a preferred embodiment of the present invention;

FIG. 3 is a simplified flow chart of a prepaid card transaction process constructed and operative in accordance with a preferred embodiment of the present invention; and

FIG. 4 is a simplified flowchart of a portion of the prepaid card transaction process of FIG. 3.

### DETAILED DESCRIPTION OF A PREFERRED EMBODIMENT

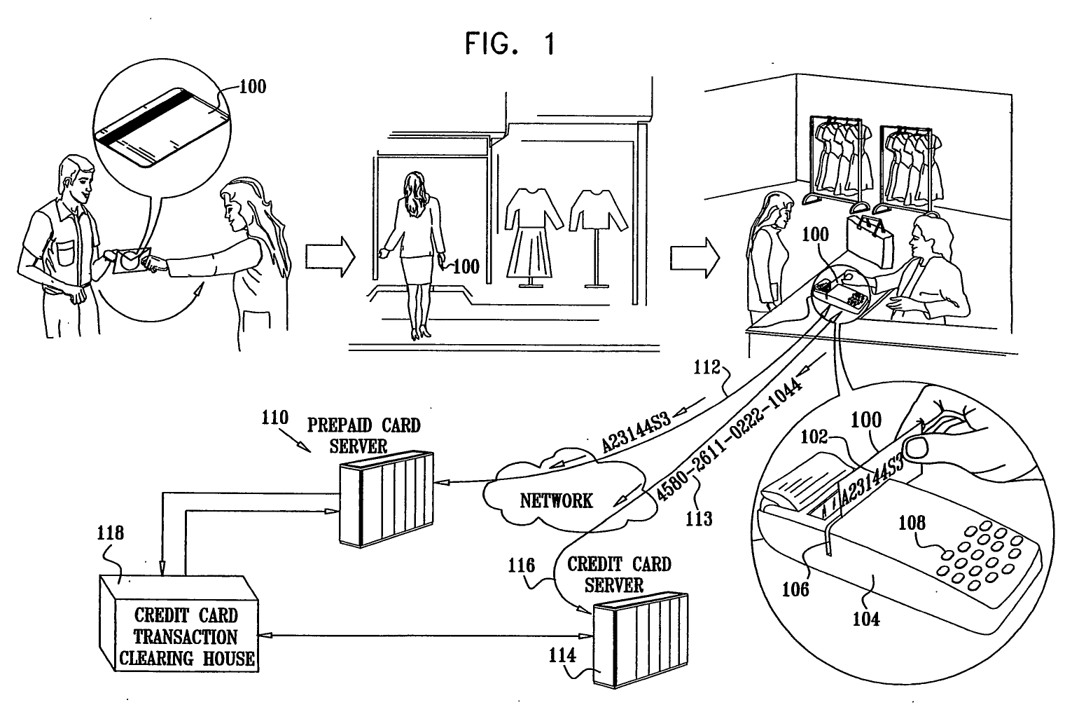

Reference is now made to FIG. 1, which is a simplified pictorial illustration of a prepaid card transaction process constructed and operative in accordance with a preferred embodiment of the present invention.

As seen in FIG. 1, a user typically receives a prepaid card 100, such as a pre-paid gift card or gift voucher. The user enters a store and presents prepaid card 100 to a vendor in payment for goods provided. Prepaid card 100 is preferably a magnetically or digitally encoded card, but may comprise any suitable prepaid card, such as a printed voucher, including identification indicia, such as a prepaid card number 102, thereon. The prepaid card number 102 is input into a conventional point of sale (POS) terminal 104 or a conventional electronic cash register, such as a NURIT®3020, NURIT®8000 or NURIT®2056, commercially available from Lipman Electronic Engineering, LTD., 11 Haamal St., Park Afek, Rosh Haayin, Israel, typically by swiping card 100 in a card reader portion 106 of POS terminal 104. Alternatively, prepaid card number 102 is entered into POS terminal 104 through any other suitable method, such as typing on a keypad 108 or scanning with a barcode reader (not shown).

It is noted that prepaid card 100 is typically one of a multiplicity of prepaid cards issued by a prepaid card issuer and is typically associated with a financial account of the prepaid card issuer that is to be charged with the monetary value associated with any purchases made using prepaid card 100.

It is appreciated that prepaid card number 102 provides information enabling prepaid card 100 to be uniquely identified so as to ensure that the appropriate financial transactions can be performed to complete a vendor payment process. If prepaid card 100 is a magnetically or digitally encoded card, this information may include a card identification number and a card issuer bank account identification number. Alternatively, the card identification number may be associated with a card issuer bank account in any conventional manner. If prepaid card 100 is a printed voucher, the prepaid sum is preferably printed on the voucher.

Following receipt of the prepaid card number 102, as described above, point of sale terminal 104 is operative to communicate the prepaid card number 102 to a prepaid card server 110 for validation, via any suitable communication network 112, such as a dial-up line or the Internet. Prepaid card server 110 preferably checks the validity of prepaid card 100 and confirms the validity of the prepaid card issuer and the balance of prepaid card 100. Prepaid card server 110 is typically operative to provide validation information of prepaid card 100 and an acceptance or rejection code for the specific transaction to point of sale terminal 104 via the communication network 112.

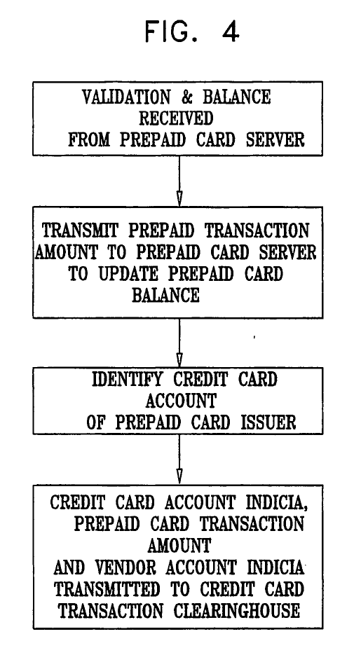

Following receipt of validation information, the point of sale terminal 104 is operative to identify a credit card account of the prepaid card issuer, as described further hereinbelow with reference to FIG. 4, and to transmit information indicia associated with the credit card account, such as a credit card number 113, and other transaction information, such as the amount of the transaction and a vendor account number, to a conventional credit card server 114 via any suitable communication network 116, such as a dial-up line or the Internet. Credit card server 114 is then operative to process a financial transaction using the credit card account of the prepaid card issuer to debit an account of the prepaid card issuer and to credit the account of the vendor, typically by communicating the details of the financial transaction to a credit card transaction clearinghouse 118 or other financial system.

Additionally, prepaid card server 110 is typically operative to communicate with the credit card transaction clearinghouse 118 or other financial system to verify and update the status of the accounts of various prepaid card issuers.

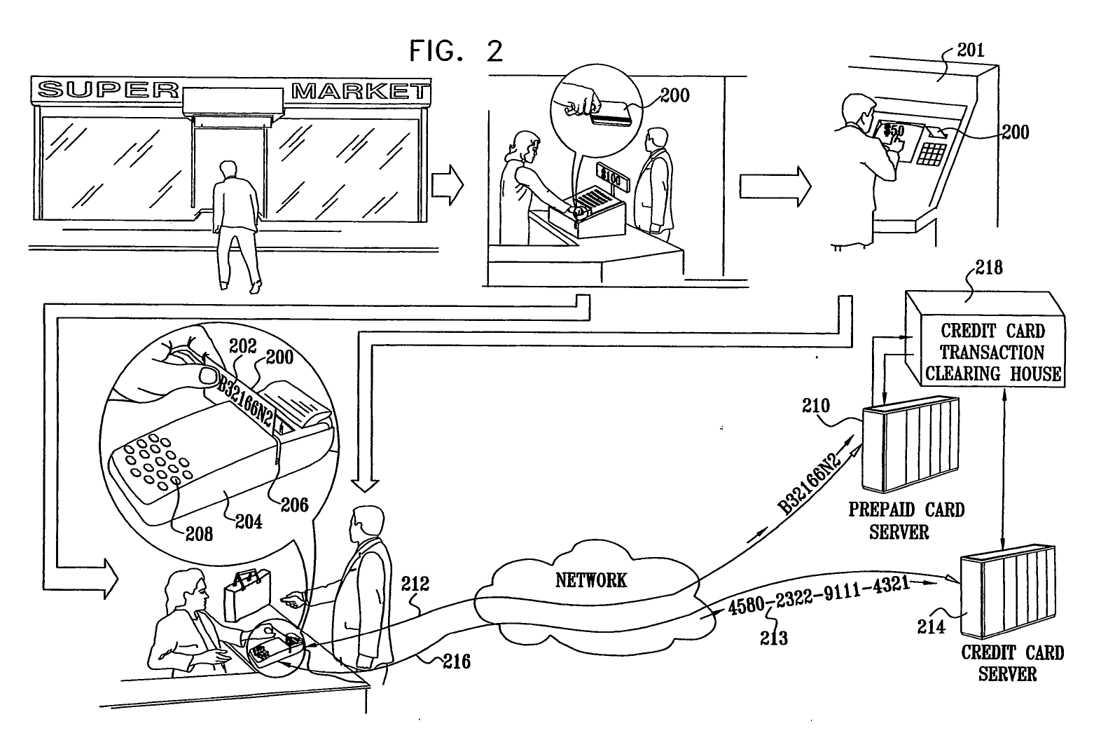

Reference is now made to FIG. 2, which is a simplified pictorial illustration of another prepaid card transaction process constructed and operative in accordance with a preferred embodiment of the present invention.

As seen in FIG. 2, a user typically purchases a prepaid card 200, such as a reusable pre-payable prepaid card or debit voucher. Prepaid card 200 is typically provided with an initial value at the time of purchase by a user, using any suitable method, such as magnetically or digitally encoding prepaid card 200. Additionally, the user may add value to prepaid card 200, typically at a prepaid card value adding terminal 201. Alternatively, value may be added to prepaid card 200 in any other suitable manner, such as at a bank or other financial services provider. It is appreciated that prepaid card 200 may be presented multiple times to have value added to it, at any suitable value adding location, both prior to and subsequent to its use for payment of goods and/or services, as described hereinbelow.

The user presents prepaid card 200 to a vendor in payment for goods provided. Prepaid card 200 is preferably a magnetically or digitally encoded card, but may comprise any suitable prepaid card, such as a printed voucher, including identification indicia, such as a prepaid card number 202, thereon. The prepaid card number 202 is input into a conventional point of sale (POS) terminal 204 or electronic cash register, such as a NURIT®3020, NURIT®8000, or NURIT®2056, commercially available from Lipman Electronic Engineering, LTD., 11 Haamal St., Park Afek, Rosh Haayin, Israel, typically by swiping card 200 in a card reader portion 206 of POS terminal 204. Alternatively, prepaid card number 202 is entered into POS terminal 204 through any other suitable method, such as typing on a keypad 208 or scanning with a barcode reader (not shown).

It is noted that prepaid card 200 is typically one of a multiplicity of prepaid cards issued by a prepaid card issuer and is typically associated with a financial account of the prepaid card issuer that is to be charged with the monetary value associated with any purchases made using prepaid card 200.

It is appreciated that prepaid card number 202 provides information enabling prepaid card 200 to be uniquely identified so as to ensure that the appropriate financial transactions can be performed to complete a vendor payment process. If prepaid card 200 is a magnetically or digitally encoded card, this information may include a card identification number and a card issuer bank account identification number. Alternatively, the card identification number may be associated with a card issuer bank account in any conventional manner. If prepaid card 200 is a printed voucher, the prepaid sum is preferably printed on the voucher.

Following receipt of the prepaid card number 202, as described above, point of sale terminal 204 is operative to communicate the prepaid card number 202 to a prepaid card server 210 for validation, via any suitable communication network 212, such as a dial-up line or the Internet. Prepaid card server 210 preferably checks the validity of prepaid card 200 and confis the validity of the prepaid card issuer and the balance of prepaid card 200. Prepaid card server 210 is typically operative to provide validation information of prepaid card 200 and an acceptance or rejection code for the specific transaction to point of sale terminal 204 via the communication network 212.

Following receipt of validation information, the point of sale terminal 204 is operative to identify a credit card account of the prepaid card issuer, as described further hereinbelow with reference to FIG. 4, and to transmit information indicia associated with the credit card account, such as a credit card number 213, and other transaction information, such as the amount of the transaction and a vendor account number, to a conventional credit card server 214 via any suitable communication network 216, such as a dial-up line or the Internet. Credit card server 214 is then operative to process a financial transaction using the credit card account of the prepaid card issuer to debit an account of the prepaid card issuer and to credit the account of the vendor, typically by communicating the details of the financial transaction to a credit card transaction clearinghouse 218 or other financial system.

Additionally, prepaid card server 210 is typically operative to communicate with the credit card transaction clearinghouse 218 or other financial system to verify and update the status of the accounts of various prepaid card issuers.

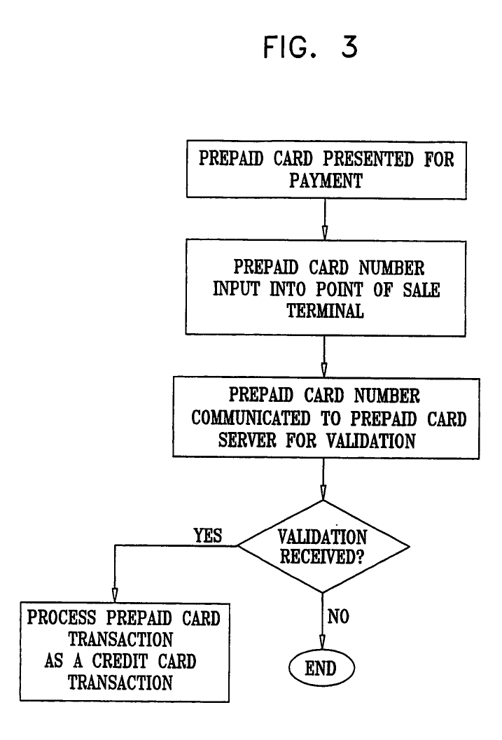

Reference is now made to FIG. 3, which is a simplified flow chart of a prepaid card transaction process constructed and operative in accordance with a preferred embodiment of the present invention.

As seen in FIG. 3, a user presents a prepaid card, such as prepaid card 100 of FIG. 1 or prepaid card 200 of FIG. 2, for payment, typically to a sales or service representative at a location equipped with a point of sale terminal, such as point of sale terminal 104 of FIG. 1 or point of sale terminal 204 of FIG. 2. The sales or service representative then proceeds to input the prepaid card number, such as prepaid card number 102 or prepaid card number 202, into the point of sale terminal, typically through a card reader portion of the point of sale terminal, such as card reader portion 106 of FIG. 1 or card reader portion 206 of FIG. 2.

The point of sale terminal then communicates the prepaid card number to a prepaid card server, such as prepaid card server 110 of FIG. 1 or prepaid card server 210 of FIG. 2. The prepaid card server may be embodied in one or more physical servers and preferably checks the validity of the prepaid card and confirms the validity of the prepaid card issuer and the balance of the prepaid card. The prepaid card server is typically operative to provide validation information of the prepaid card and an acceptance or rejection code for the specific transaction to the point of sale terminal. The point of sale terminal, upon receiving validation of the prepaid card from the server, then proceeds to process the prepaid card transaction as though it were a credit card transaction, as described further hereinbelow, with reference to FIG. 4.

Reference is now made to FIG. 4, which is a simplified flow chart of a portion of the prepaid card transaction process of FIG. 3.

As seen in FIG. 4, upon receipt of validation of the prepaid card from the prepaid card server, the point of sale terminal proceeds to transmit the appropriate information to process the financial transaction. The point of sale terminal transmits the amount to be debited from the prepaid card balance to the prepaid card server, which is then operative to reduce the available balance of the prepaid card. It is appreciated that the point of sale terminal is preferably operative to ensure that the amount to be debited does not exceed the current available balance of the prepaid card.

As seen further in FIG. 4, the point of sale terminal is also operative to identify a credit card account associated with the prepaid card issuer. It is appreciated that this credit card account identification functionality may be resident in the point of sale terminal, such as a lookup table based on the identification indicia of the prepaid card, or may be resident in the prepaid card server and may be communicated to the point of sale terminal. Alternatively, the point of sale terminal may include a processor including logic used to identify the credit card account based on the information indicia of the prepaid card.

After the point of sale terminal has identified a credit card account associated with the prepaid card issuer, the point of sale terminal then proceeds to process the prepaid card transaction as a conventional credit card transaction, using credit card indicia associated with the credit card account. This is typically achieved by transmitting the credit card indicia, the amount of the prepaid card transaction and vendor account indicia to a credit card transaction clearinghouse, such as clearinghouse 118 of FIG. 1 or clearinghouse 218 of FIG. 2. The credit card transaction clearinghouse is then operative to process a conventional credit card financial transaction debiting the credit card account of the prepaid card issuer and crediting the account of the vendor with the amount of the transaction. Additionally, the credit card transaction clearinghouse is typically operative to communicate with the prepaid card server to confirm that the amount of the transaction that was debited to the prepaid card balance is the same as the amount that was debited from the prepaid card issuer and credited to the vendor.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method for processing prepaid card transactions comprising:
issuing, by a prepaid card issuer, a multiplicity of prepaid cards, each bearing prepaid card identification indicia;
inputting the prepaid card identification indicia of a prepaid card into a point of sale terminal;
communicating said prepaid card identification indicia from the point of sale terminal to a remote server to validate said prepaid card; and
upon receipt of acceptable validation from said remote server, processing a prepaid card transaction using the prepaid card as a credit card transaction employing a credit card account associated with said prepaid card issuer.

2. A method for processing prepaid card transactions according to claim 1 and wherein said processing a prepaid card transaction includes:
providing credit card identification indicia for said credit card account; and
charging said credit card account, identified by said credit card identification indicia, for the amount of said prepaid card transaction.

3. A method for processing prepaid card transactions according to claim 2 and wherein said credit card account corresponds to at least a plurality of said multiplicity of prepaid cards.

4. A method for processing prepaid card transactions according to claim 2 and wherein said credit card identification indicia is stored at said point of sale terminal.

5. A method for processing prepaid card transactions according to claim 4 and wherein said credit card identification indicia is accessed at said point of sale terminal using said prepaid card identification indicia.

6. A method for processing prepaid card transactions according to claim 2 and wherein said credit card identification indicia is stored at said remote server.

7. A method for processing prepaid card transactions according to claim 6 and wherein said credit card identification indicia is accessed at said remote server using said prepaid card identification indicia.

8. A method according to claim 1 and wherein said inputting comprises reading said identification indicia.

9. A method according to claim 1 and wherein said inputting comprises keying in said identification indicia.

10. A method according to claim 1 and wherein said acceptable validation comprises balance information.

11. A point of sale terminal comprising:
an input device operative to receive prepaid card identification indicia from a prepaid card issued by a prepaid card issuer; and
a processor, operative to process a prepaid card transaction using the prepaid card as a credit card transaction employing a credit card account associated with said prepaid card issuer.

12. A point of sale terminal according to claim 11 and wherein said input device is a card reader.

13. A point of sale terminal according to claim 11 and wherein said input device is a keyboard.

14. A point of sale terminal according to claim 11 and wherein said processor is operative to verify acceptable validity of said prepaid card prior to processing said prepaid card transaction.

15. A point of sale terminal according to claim 11 and wherein said processor is operative to verify a balance associated with said prepaid card prior to processing said prepaid card transaction.

16. A point of sale terminal according to claim 11 and also comprising a communicator, operative to communicate said prepaid card identification indicia to a remote server to determine validity of said prepaid card.

17. A point of sale terminal according to claim 16 and wherein said remote server is operative to communicate a balance in said prepaid card, via said communicator, to said terminal.

18. A point of sale terminal according to claim 11 and wherein said processor is operative to identify said credit card account by credit card identification indicia and to charge said credit card account for the amount of said prepaid card transaction.

19. A point of sale terminal according to claim 18 and also comprising a storage device for storing said credit card identification indicia.
